(19) United States
(12) Patent Application Publication
(10) Pub. No.: US 2014/0043478 A1
(43) Pub. Date: Feb. 13, 2014

(54) SECURITY CAMERA ASSEMBLY

(71) Applicant: Philip Burton, Cheshire (GB)

(72) Inventor: Philip Burton, Cheshire (GB)

(73) Assignee: 360Vision Technology limited, Cheshire (GB)

(21) Appl. No.: 14/002,115

(22) PCT Filed: Feb. 24, 2012
(86) PCT No.: PCT/GB12/50430

§ 371 Date: Oct. 9, 2013

(30) Foreign Application Priority Data
Feb. 28, 2011 (GB) 1103367.7

(51) Int. Cl. G08B 13/196

(52) U.S. Cl. CPC G08B 13/196; G08B 13/1963
USPC 348/143

(57) ABSTRACT

A security camera assembly is provided that includes a camera. The camera is adjustable to be sensitive to both visible light for producing monochrome and/or colour images and to non-visible radiation for producing monochrome images. The camera is mounted in a housing that is adjustable about two mutually perpendicular axes (i.e. pan and tilt) to define an area monitored by the camera. Illumination means are provided on the housing to move with the camera illuminating the area monitored by the camera. The illumination means includes a source of visible light and a source of non-visible (e.g. infra-red) radiation to which the camera is adjustable to be sensitive. Either the source of visible light or the source of non-visible radiation being separately selectable.

The present invention relates to security camera assemblies.

Security cameras are used to provide images of an area which requires monitoring, for example for security reasons. Security cameras can be located internally or externally. They may have a fixed direction of view or may be able to pan and/or tilt so as to be able to monitor a larger area. The field of view of the camera may also be adjusted, allowing a zoom capability. These adjustments and the monitoring of the images are usually carried out remotely.

Some security cameras rely on ambient natural light, or light provided by external light sources, such as street lighting or floodlighting, to illuminate the scene being monitored by the camera. Other security cameras have a source of illumination attached to the camera, thereby providing a source of illumination for the camera in the monitored area. Known security cameras utilise either infra-red (IR) illumination, which allows a monochrome image to be detected, or white light illumination, which allows a colour image to be detected. Each type has its advantages and drawbacks.

The use of white light to illuminate a monitored area allows the recording of colour images, which is helpful when identifying potentially important details, such as the colour of clothing or other objects. However, constant illumination with white light is both wasteful and expensive and, in addition, is often considered as a social nuisance to nearby residents.

For the avoidance of doubt, in this specification the term “visible light” includes, but is not limited to, light which the eye perceives substantially as white.

If infra-red light is used to illuminate an area monitored by a security camera, it is invisible to the naked eye and is therefore unlikely to be considered as social nuisance in itself. However, a security camera system recording images in the infra-red region is only able to record monochrome images. Furthermore, a security camera system utilising IR illumination does not provide any warning effect to a person being monitored.

Colour surveillance cameras have an IR cut-filter fitted between the lens and the image sensor. This prevents IR radiation which is present in daylight from being detected which would spoil the colour picture. Mono cameras have no IR cut-filter.

Hybrid security camera systems are also known, which utilise a colour camera for recording colour images during the day (or for as long as the ambient illumination is sufficient) and have an electromechanically movable IR cut-filter which is disengaged when the ambient illumination is insufficient for colour images to be satisfactorily viewed. In that case, IR illumination sources mounted on the camera are used to illuminate the monitored area and monochrome images of the area are generated.

It is an aim of the present invention to provide a security camera which overcomes or alleviates the problems associated with the prior art.

According to a first aspect of the present invention, a security camera assembly comprises an imaging means which is adjustable to be sensitive to both visible light for producing monochrome and/or colour images and to non-visible radiation for producing monochrome images, means for remotely adjusting the position of the imaging means to define an area to be monitored by the imaging means, illumination means which move with the imaging means to illuminate the an area monitored by the imaging means, the illumination means comprising a source of visible light and a source of non-visible radiation to which the imaging means can be adjusted to be sensitive, and means for selecting either the source of visible light or the source of non-visible radiation for illuminating the area monitored by the imaging means.

Such a security camera assembly is capable of providing colour images during daylight hours, and in low light conditions the camera can operate in IR mode, lighting the scene with invisible IR radiation and recording a monochrome image. Recording an image under IR illumination in this manner avoids any light pollution or nuisance issues. However, if required, colour images may be obtained by illuminating the scene with the source of visible light.

In addition to allowing colour images to be produced, the switching on of the visible light source will indicate to individuals being observed that they are under surveillance and is therefore likely to act as a deterrent. Once colour images are no longer required, the white light source can be extinguished and imaging can be resumed in monochrome under IR illumination. Thus, visible light illumination is used only when required. The system therefore uses less power than systems requiring a continuously illuminated source of visible light and is therefore less expensive to run and is an environmentally friendly alternative to known systems.

In a preferred embodiment, the illumination means is fixed with respect to the imaging means.

The security camera assembly preferably further comprises a housing within which the imaging means is located.

Preferably, the imaging means is secured to, and moves with, the housing and the means for remotely adjusting the position of the imaging means comprises means for remotely adjusting the position of the housing.

Preferably, the illumination means is secured to the housing.

Preferably, the position of the imaging means is adjustable about two axes, e.g. two mutually perpendicular axes (i.e. a “pan and tilt” adjustment).

The camera assembly may further comprise a filter which is selectively disposable in front of the imaging means. Preferably, the filter is adapted to prevent the passage of the non-visible radiation.

In a preferred embodiment, the source of visible light comprises one or more light-emitting diodes. Alternatively, or in addition, the source of non-visible radiation preferably comprises one or more light-emitting diodes.

Preferably, the non-visible radiation comprises infra-red radiation.

In accordance with a second aspect of the present invention, a security camera assembly comprises imaging means, illumination means for selectively illuminating an area monitored by the imaging means and means for measuring at least one parameter of the radiation received by the imaging means and means for controlling the actuation and/or the intensity of the illumination means on the basis of the at least one measured parameter.

With such a camera assembly, the parameters are those detected by the imaging means itself rather than by a separate sensor located adjacent to the camera. Consequently, it is possible to provide a more accurate determination of when the means for selectively illuminating the area monitored by the imaging means should be actuated and to control the intensity of such illumination. By adjusting the intensity of illumination, in particular by dimming the illumination when one or more of the parameters (either alone or in combination with one or more of the other parameters) indicates that the illumination is excessive, image quality can be optimised and energy savings can be made.

The at least one parameter may be selected from the group comprising the iris setting for the image sensor, the gain setting for amplification of a video signal produced by the image sensor, the shutter speed for integration level, brightness level, the colour content of the detected light and the brightness levels at one or more defined wavelengths or wavelength ranges.

These parameters are automatically adjusted by the camera to suit the available illumination. A single parameter can be used for control of IR illumination. Further improvement in the control is made by using more than one parameter. An example of this would be when the iris is fully open and gain is set to maximum, these two parameters combine together to indicate that the illumination is at a low level. The shutter speed is used to increase the resolution of the measurement of the level of the illumination. The result is adjusted to take account of variation caused by the IR cut-filter, and whether the IR or white light illuminations are currently on.

The security camera assembly may comprise a security camera assembly in accordance with the first aspect of the present invention.

In accordance with a third aspect of the present invention, a method of controlling a security camera assembly comprising imaging means and illumination means for selectively illuminating an area monitored by the imaging means, comprises the steps of measuring at least one parameter of the radiation received by the imaging means and controlling the actuation and/or the intensity of the illumination means on the basis of the at least one measured parameter.

The at least one parameter may be selected from the group comprising the iris setting for the image sensor, the gain setting for amplification of a video signal produced by the image sensor, the shutter speed for integration level, brightness level, the colour content of the detected light and the brightness levels at one or more defined wavelengths or wavelength ranges.

By adjusting the intensity of illumination, in particular by dimming the illumination when one or more of the parameters (either alone or in combination with one or more of the other parameters) indicates that the illumination is excessive, image quality can be optimised and energy savings can be made.

The security camera assembly may comprise a security camera assembly in accordance with the first or second aspects of the present invention.

By way of example only, the invention will now be described with reference to the accompanying drawings.

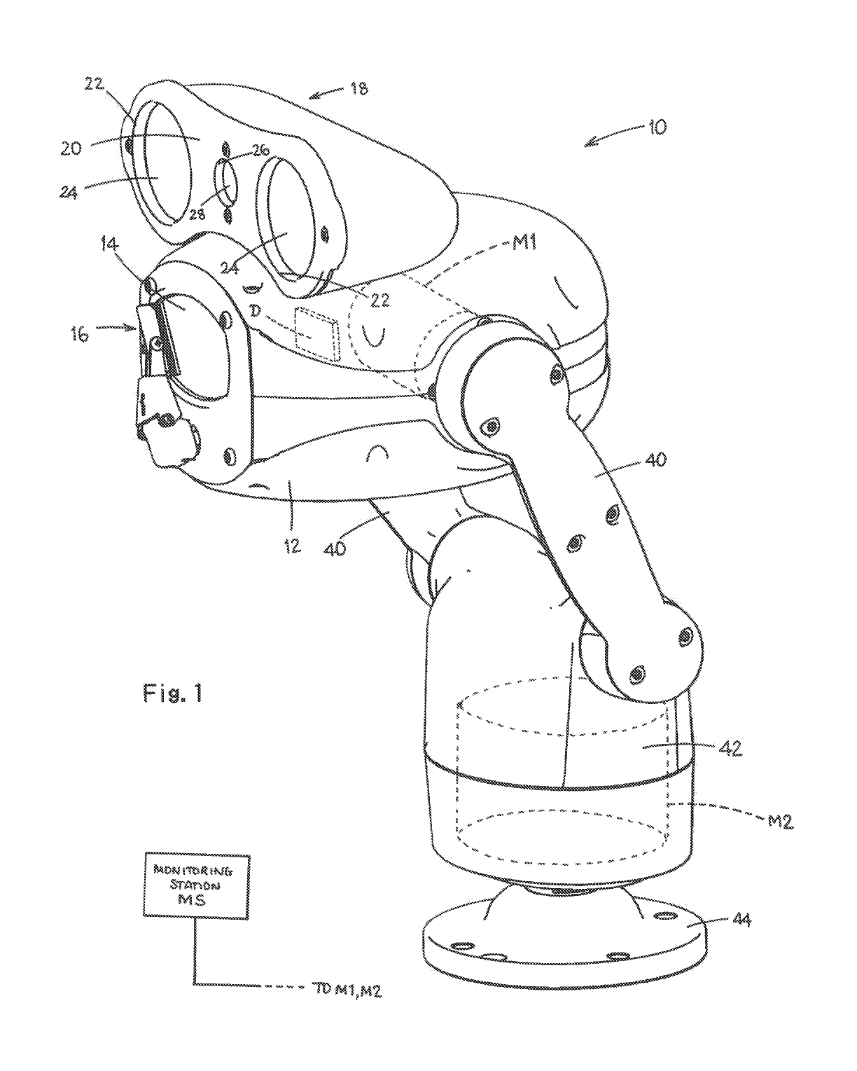

FIG. 1 is a perspective view of an embodiment of security camera assembly in accordance with the present invention;

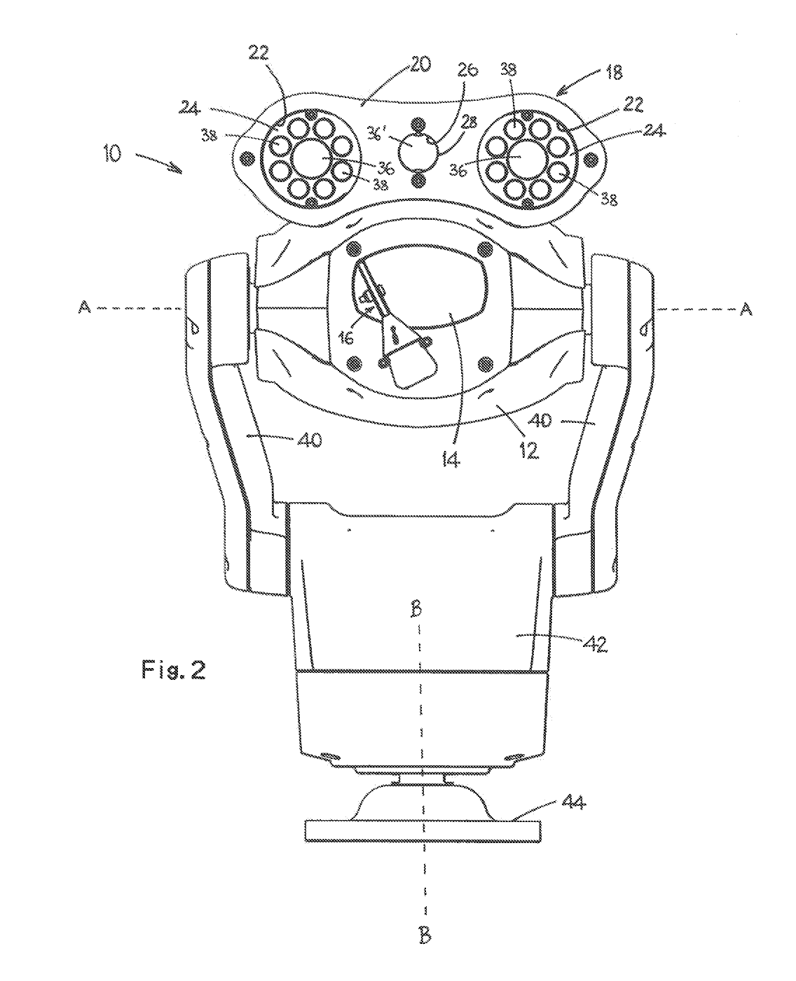

FIG. 2 is a front view of the security camera assembly of FIG. 1;

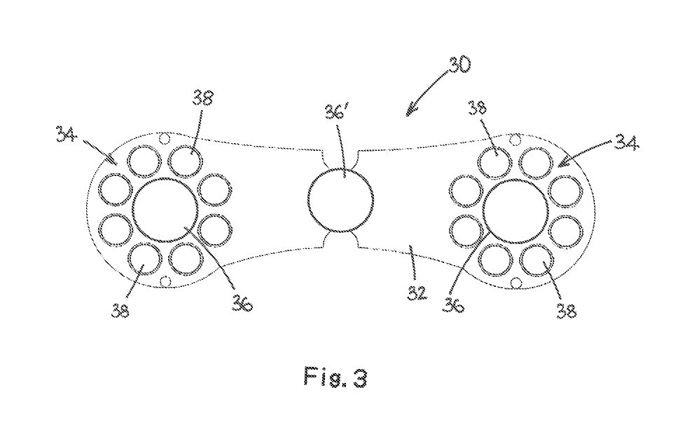

FIG. 3 is a front view of a printed circuit board forming part of the security camera assembly of FIG. 1;

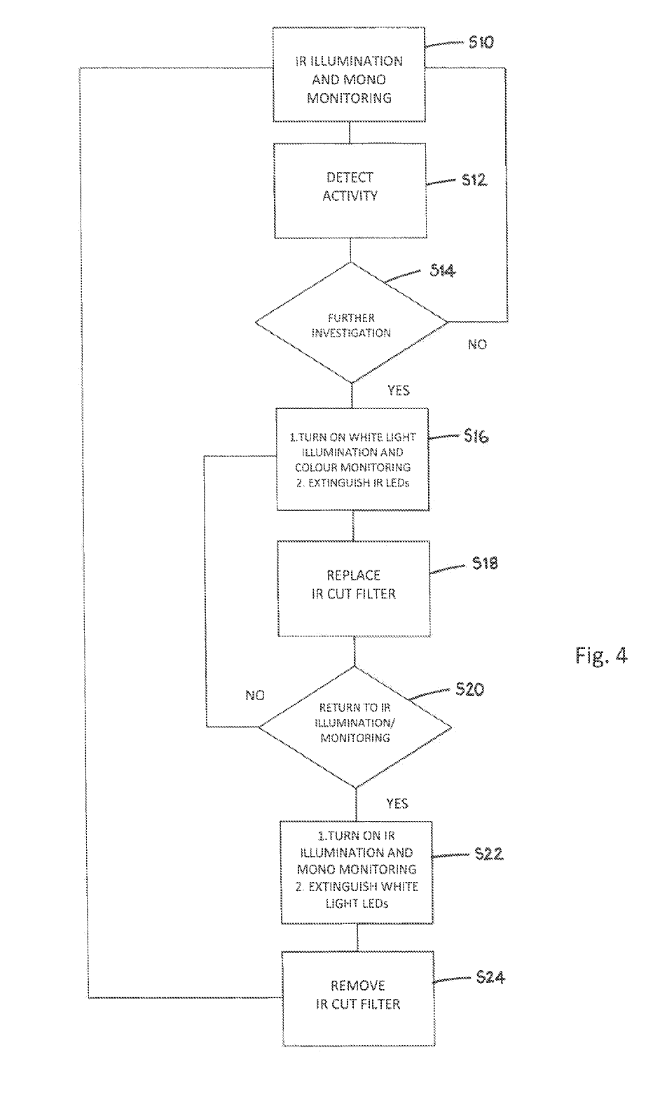

FIG. 4 is a flow diagram illustrating the operation of the security camera assembly of FIG. 1, when the IR illumination sources are operative (IR mode); and

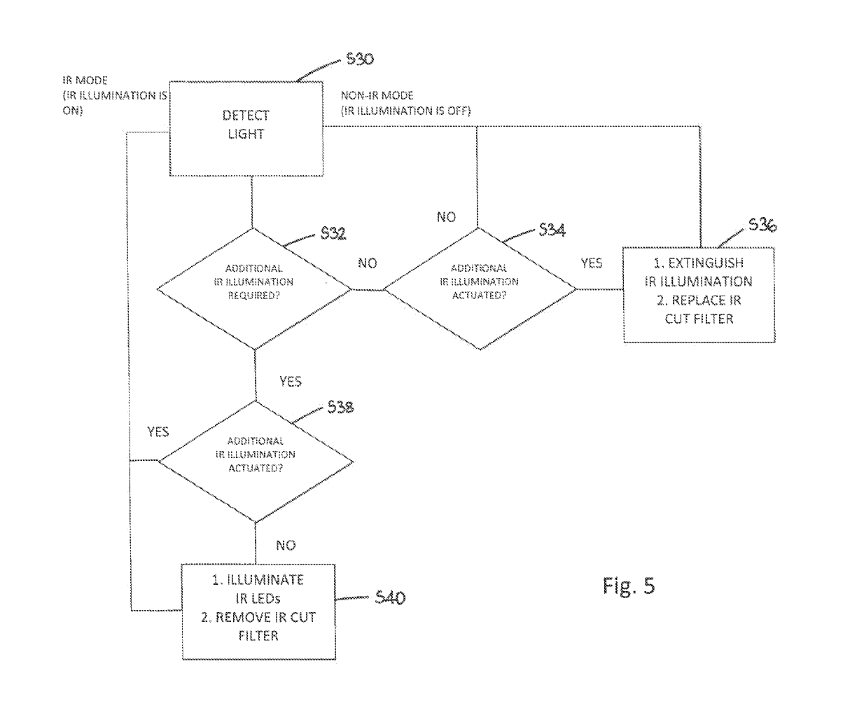

FIG. 5 is a flow diagram illustrating the method of determining whether the IR illumination sources are to be operative (IR mode) or not (non-IR mode);

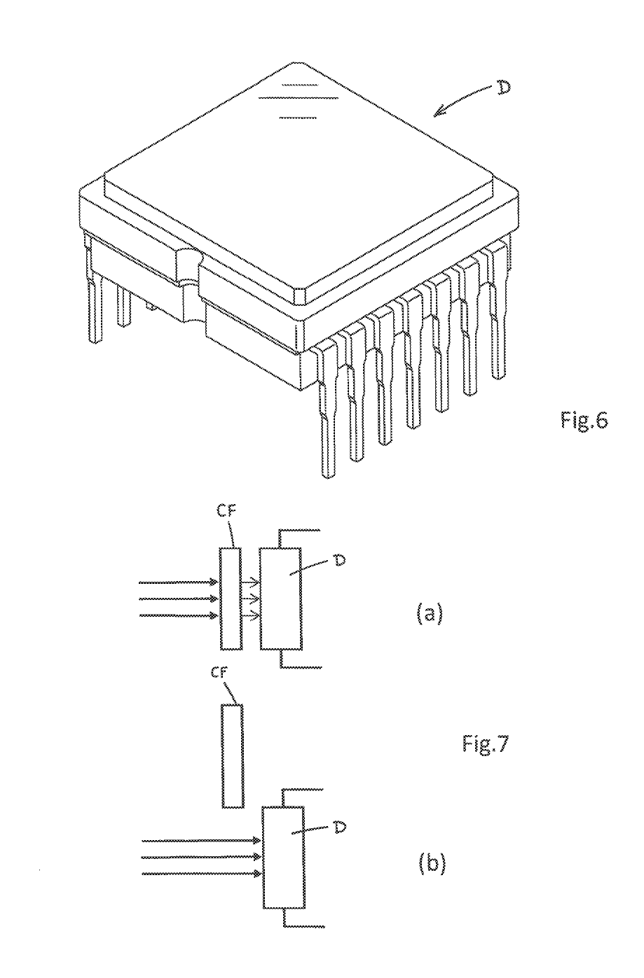

FIG. 6 is a perspective view of an image sensor forming part of the security camera assembly of FIG. 1; and

FIG. 7 is a schematic illustration of the operation of an infra-red cut-filter which forms part of the security camera assembly of FIG. 1.

Referring firstly to FIGS. 1 and 2, a security camera assembly 10 comprises a camera housing 12 within which an image detector (shown schematically at D in FIG. 1 and illustrated in FIG. 6) is located. The housing 12 has a window 14 in a front face which is transparent to visible light and infra-red (IR) radiation. A reciprocable wiper 16 is pivotally mounted below the window and is operable to wipe the outer surface of the window 14.

The camera housing 12 also incorporates a conventional electromechanically movable IR cut-filter (CF, FIG. 7) which is moved to a position in front of the image detecting system when it is desired to record images illuminated by IR radiation, as will be explained.

An illumination source housing 18 is secured to the top of the camera housing 12. As will be explained, the position of the camera housing 12 can be adjusted and the securing of the illumination source housing 18 to the camera housing 12 ensures that the two move together.

The illumination source housing 18 comprises a generally twin-lobed, kidney-shaped front face 20 having two larger circular apertures 22 closed off by windows 24 transparent to visible light and IR radiation, each located in a respective one of the two lobes of the front face, and a smaller circular aperture 26 located midway between the two larger apertures 22 and dosed of by a window 28 transparent to at least visible light.

FIG. 3 illustrates a circuit board 30 forming part of the illumination source, comprising a planar base 32 of generally the same twin-lobed kidney shape as the front face 20 of the illumination source housing 18. Each of the lobes of the base is provided with one of two identical dusters 34 of illumination devices, comprising a central large light-emitting diode 36 emitting visible (preferably white) light surrounded by eight identical, equally angularly spaced IR-emitting LEDs 38. A further large LED 36′, identical to the LEDs 36 of the dusters 34, is located midway between the dusters 34. The dusters 34 and the LED 36′ are positioned on the board 30 so that when the board is mounted within the illumination source housing 18 they lie immediately behind the two windows 24 and the window 28 respectively, as shown in FIG. 1.

The camera housing is pivotally mounted about a horizontal axis A-A between the distal ends of a pair of supporting arms 40. The other ends of the arms are rigidly mounted to diametrically opposite sides of a camera drive motor housing 42. The camera housing 12 can be pivotally displaced about the horizontal axis A-A by a motor (shown schematically as M1) within the housing 12 and the housing itself can be pivoted about a vertical axis B-B with respect to a mounting base 44 by a further motor (shown schematically as M2) within the housing 42. In this way, the inclination and the rotational position of the camera housing 12 (and of the illumination source housing 18 mounted on the camera housing 12) can be adjusted. The inclination and position of the camera is typically adjusted remotely under the control of personnel at a remote monitoring station (shown schematically as MS) who can send signals to the installation to operate the motors in the housings 12 and 42 to make the appropriate adjustments.

The operation of the camera assembly will be explained with reference to the flow diagram of FIG. 4. In the following, the description of the operation and in FIG. 4, “step” is abbreviated to “S”.

If the camera assembly is operating in light conditions which do not require additional illumination (e.g. in daylight or if sufficient illumination is provided by an external source), neither the white light LEDs 36, 36 nor the IR LEDs 38 are activated and the camera relies on ambient light for illumination of the monitored area. In this condition, the conventional electromechanically movable IR cut-filter is moved to be in front of the image detecting system, as shown in FIG. 7(a), so that colour images (or monochrome images, if preferred) are detected. The images are monitored remotely, in the conventional manner.

When it is determined that additional IR illumination is required (typically if the level of light provided by natural daylight is insufficient to detect colour images satisfactorily) the IR LEDs 38 are actuated and the conventional electromechanically movable IR cut-filter is removed from the front of the image detecting system, as shown in FIG. 7(b). The monitored area is thereby illuminated with IR radiation and the camera detects IR images (S10).

When in the IR illumination mode, if a person monitoring the detected images determines that further visual information is necessary which cannot be obtained from IR illumination and detection, e.g. if suspicious activity is detected (S12), a decision is taken (S14) as to whether further investigation is required. If so, the white light LEDs 36, 36′ are actuated and the IR LEDs 38 are de-activated (S16) and the IR cut-filter is moved to be in front of the image detecting system (S18). The monitored area is thereby illuminated with white light and the camera detects colour images, which provide significantly more detail. The illumination by white light usually also serves as a warning to a person being illuminated that they are being visually monitored.

When it is decided that colour images are no longer required and that the system should return to IR illumination and monitoring (S20) the white light LEDs 36, 36′ are extinguished and the IR LEDs are actuated (S22) and the IR Cut-Filter is removed from the front of the image detecting system (S24). The monitoring then continues as previously (S10).

In tandem with the above sequence, the system is continuously monitoring the incoming ambient light to determine whether additional illumination from the illumination source housing 18 is required or whether ambient light is sufficient. However, in contrast to prior art systems, this does not use a separate light sensor, but instead relies on the signals detected by the image sensor itself (in combination with appropriate analysing software) to determine whether the ambient light is sufficient to detect colour images satisfactorily. In this way, the actual signals detected by the image sensor are used in the determination, rather than using separate signals from a separate sensor, which may be affected by extraneous light sources and which is likely to require accurate calibration.

The monitoring sequence is illustrated in the flow chart of FIG. 5 in which “step” has been abbreviated to “S”.

At S30, one of more parameters of the light sensed by the image sensor is detected and after analysis (S32) it is determined whether additional illumination is required. For example, the parameters may include, but are not limited to, the intensity of radiation detected, the iris setting for the image sensor, the gain setting for amplification of a video signal produced by the image sensor, the shutter speed for the integration level, brightness level, the colour content of the detected light and the brightness levels at one or more defined wavelengths or wavelength ranges. If one or more of the detected parameters (either when considered individually or in combination with one or more of the other parameters) indicates that the illumination is excessive, the intensity of the illumination may be reduced or dimmed, which improves image quality and provides an energy saving.

If not, the sequence moves to S34 when it is determined whether additional illumination is actuated. If not, the sequence returns to S30. If yes, at S36 the additional illumination is extinguished and the IR cut-filter is repositioned in front of the image sensor. The camera picture is switched to mono. The sequence then returns to S30.

At S32, if it is decided that additional illumination is required, the sequence moves to S38, where it is determined whether additional illumination is already active. If yes, the sequence returns to S30. If not, at S40 the IR LEDs 38 are illuminated and the IR cut-filter is moved in front of the image sensor and the camera is switched to colour. The sequence then returns to S30.

The invention is not restricted to the details of the foregoing embodiment.

1. A security camera assembly, comprising:
an imaging unit that is adjustable to be sensitive to (1) visible light for producing at least one of monochrome and colour images and (2) non-visible radiation for producing monochrome images,
an adjusting unit for remotely adjusting a position of the imaging unit to define an area to be monitored by the imaging unit,
an illumination unit that moves with the imaging unit to illuminate the area to be monitored by the imaging unit, the illumination unit comprising a source of visible light and a source of non-visible radiation to which the imaging unit is adjustable, and
a selecting unit for selecting either the source of visible light or the source of non-visible radiation for illuminating the area monitored by the imaging unit.

2. The security camera assembly of claim 1, the illumination unit being relatively fixed with respect to the imaging; unit.

3. The security camera assembly of claim 2, further comprising a housing within which the imaging unit is located.

4. The security camera assembly of claim 3, the imaging unit being secured to and caused to move with the housing and the adjusting unit further comprising a housing adjusting unit for remotely adjusting a position of the housing.

5. The security camera assembly of claim 3, the illumination unit being secured to the housing.

6. The security camera assembly of claim 1, the position of the imaging unit being adjustable about two axes.

7. The security camera assembly of claim 6, the position of the imaging unit being adjustable about two mutually perpendicular axes.

8. The security camera assembly of claim 1, further comprising a filter which is selectively disposable in front of the imaging unit.

9. The security camera assembly of claim 8, the filter being adapted to prevent passage of the non-visible radiation.

10. The security camera assembly of claim 1, the source of visible light comprising one or more light-emitting diodes.

11. The security camera assembly of claim 1, the source of non-visible radiation comprising one or more light-emitting diodes.

12. The security camera assembly of claim 1, the non-visible radiation comprising infra-red radiation.

13. A security camera assembly, comprising:
imaging means,
illumination means for selectively illuminating an area monitored by the imaging means,
measuring means for measuring at least one parameter of the radiation received by the imaging means, and
controlling means for controlling at least one of actuation and intensity of the illumination means based on the at least one measured parameter.

14. The security camera assembly of claim 13, the at least one measured parameter being selected from a group consisting of an iris setting for the imaging sensor, a gain setting for amplification of a video signal produced by the imaging means, a shutter speed for an integration level, a brightness level, a colour content of detected light and brightness levels at one or more defined wavelengths or wavelength ranges.

15. (canceled)

16. A method of controlling a security camera assembly comprising imaging means and illumination means for selectively illuminating an area monitored by the imaging means, the method comprsing:
measuring at least one parameter of radiation received by the imaging means, and
controlling at least one of actuation and intensity of the illumination means based on the at least one measured parameter.

17. The method of claim 16, the at least one measured parameter being selected from a group consisting of an iris setting for the imaging means, a gain setting for amplification of a video signal produced by the imaging sesnsor, a shutter speed for an integration level, a brightness level, a colour content of detected light and brightness levels at one or more defined wavelengths or wavelength ranges.

18. The method of claim 16, the security camera assembly comprising a security camera assembly, comprising: (a) an imaging unit that is adjustable to be sensitive to (1) visible light for producing at least one of monochrome and colour images, and (2) non-visible radiation for producing monochrome images, (b) an adjusting unit for remotely adjusting a position of the imaging unit to define an area to be monitored by the imaging unit, (c) an illumination unit that moves with the imaging unit to illuminate the area to be monitored by the imaging unit, the illumination unit comprising a source of visible light and a source of non-visible radiation to which the imaging unit is adjustable, and (d) a selecting unit for selecting either the source of visible light or the source of non-visible radiation for illuminating the area monitored by the imaging unit.

19-20. (canceled)

21. The security camera assembly of claim 1, further comprising:
a measuring unit for measuring at least one parameter of radiation received by the imaging unit, and
a controlling unit for controlling at least one of actuation and intensity of the illumination unit based on the at least one measured parameter.
